(19) United States
(12) Patent Application Publication
(10) Pub. No.: US 2009/0309811 A1
(43) Pub. Date: Dec. 17, 2009

(54) IMAGE DISPLAY SYSTEMS

(75) Inventor: Jeremy Lynn Hinton, Bristol (GB)

Correspondence Address: PILLSBURY WINTHROP SHAW PITTMAN, LLP, P.O. BOX 10500, MCLEAN, VA, 22102, US

(73) Assignee: BAE SYSTEMS plc, London (GB)

(21) Appl. No.: 11/914,896

(22) PCT Filed: Oct. 26, 2007
(86) PCT No.: PCT/GB2007/004077

§ 371 Date: Nov. 19, 2007

(30) Foreign Application Priority Data
Oct. 31, 2006 (EP) 06255602.2
Oct. 31, 2006 (GB) 0621645.1

(51) Int. Cl. G09G 5/00

(52) U.S. Cl. 345/8

(57) ABSTRACT

In a head-mounted display system a viewed scene is optically compressed before being incident on a detector so that the peripheral regions of the image, which will appear in the viewing person's peripheral vision, are compressed more than the central region. The image is relayed to a display where an inverse optical expansion is applied, so that a wide field of view with high resolution at the centre is obtained from a relatively small display.

This invention relates to image display systems and to related methods for the display and/or compression of image data. In particular, but not exclusively, the invention relates to display systems for use where a wide field of view is required.

Flat panel displays are commonly used in aviation display roles such as head-up or head-down displays, where the display is a fixed position transparent display in the normal line of sight, and helmet-mounted displays or other head-related displays, where the display area moves with the user's head. Other applications include night vision goggles or other devices mounted on the wearer's head. In such devices it is important to have the ability to display information over a wide field of view. The presentation of high detail over a large field of view would normally require a very large number of pixels and this introduces adverse implications not only for the display technology, but also for communications storage and processing. In many instances it is desirable to make use of displays developed for commercial applications, and such displays currently have a practical upper limit of about one million pixels (e.g. SXGA1280*1024 pixels is currently a very high resolution display, with associated high computational demand).

Human visual acuity is approximately 1 minute arc and this places a figure on the preferred subtense of a display pixel. If an SXGA display is used to present high resolution images at 1 minute arc per pixel, then the field of use supported by an SXGA display will be limited to just over 21° and this would not be considered a wide field of view, and is roughly a third of the size of the 60° field of view required. in many applications. To fill a 60° field of view, each pixel would subtend nearly 3 minutes of arc at the eye, which is distinctly coarsely pixellated, and provide a noticeable lack of detail or resolution at the important central region of the image.

From the above analysis, it would appear that commercially available displays are not capable of supporting a wide field of view with high resolution over the display. In fact, previous work in this field has suggested that an ideal display requires 1000 megapixels, about a thousand times the size of an SXGA display. At present suitable forms of such display are not available and even if they were, they could not readily be addressed, or supported by existing sensors, data and processing.

Accordingly, in one aspect there is a need for a system which provides a wide field of display view with acceptable resolution to fulfill the needs of the head-up, or head-mounted display.

Our studies have indicated that, due to the way in which a user uses a head-mounted display or other head-related displays, and because of the cone and rod structure of the cells of the eye, it is possible to provide a wide field of view sensor which to the human eye is perceived to have good resolution over the entire field of view from existing commercial displays. Human vision is mediated by the cone receptor cells located at the centre of the retina. The density of these cells falls dramatically as a function of angle from the centre of fixation, with a central group of cone receptor cells at the fovea being surrounded by rod receptor cells which do not mediate in high acuity vision. Similarly, the optical quality of the eye declines with angle from the fovea, so some reduction in image quality with angular distance from the fixation point is not only acceptable, but can be unnoticeable. In practice, visual inspection involves the redirection of attention by successive fixations, where the point of regard is redirected over the field of interest. This means that resolution has to be maintained only over areas where the user might fixate. For a fixed position display, such as head-up display, this would tend to mean the full area of the display although in practice observers fixate less towards the edge of the display in a search task and so resolution at the peripheral region is not required to be so high.

However, with a display that moves with the user's head, such as a helmet-mounted display, two unique viewing conditions are presented. Firstly, many such displays are transparent with the displayed image being viewed superimposed on the outside world view. Secondly, and of particular relevance to peripheral resolution reduction, the display ‘frame’ is head-related, so the display remains in front of the user when the head is moved. When imagery or symbology is head-tracked, the head-mounted display functions as a ‘window’ which moves over a world of data which is wider than the display itself and so head pointing supplements the movements made by the eye as it does in natural vision. In natural vision, eye movements are relatively restricted, with most eye movements deviating only within 15° of the resting position. Eye movements in excess of 30° from the resting position do occur but are not sustained when the head is free to move. In other words, for a head-related display, where the head is free to move, and the display content is head-tracked, fixations will be predominantly towards the centre of the display, and rarely towards the periphery of the array.

We have therefore developed an image display system in which an optical or digital transformation is applied to the image data prior to display so that, using a display of a given resolution, a relatively wide field of view with relatively high apparent resolution may be achieved, by maintaining high resolution in the centre of the displayed image where visual acuity is sharpest, but sacrificing resolution at the peripheral region to allow a wider field of view in a region where the visual acuity is less. By modifying the resolution of the displayed image to reflect the viewer's acuity over the normal field of view a wider field of view can be achieved from a display of a given size and resolution, with an overall apparent image quality or visual resolution determined by the resolution at the centre of the displayed image. The transformation may be applied optically prior to capture of the image, or digitally after capture or where the image is computer-generated.

Accordingly, in one aspect this invention provides an image display system comprising:

a sensor for receiving from a field of view an incident image and generating corresponding image data;

input optical transformation means for applying an input optical transformation to radiation from said viewed scene before being incident upon said sensor, and

a display for receiving image data from said sensor and for displaying an image generally corresponding to the image incident on said sensor,

wherein said input optical transformation optically compresses a selected part of said incident image in at least one dimension.

In this way the effective field of view that can be captured by the sensor is increased.

The system preferably includes output optical transformation means for applying an output optical transformation to the image displayed by said display for presentation to a user, wherein said output optical transformation optically expands a part of the displayed image to that compressed by said input optical transformation means to at least partially restore the displayed image to correspond to that of the viewed scene.

In many embodiments said input optical transformation optically compresses a peripheral region of said viewed scene, leaving a remaining region substantially uncompressed. Thus the input optical transformation means may optically compress a peripheral border region extending around a generally central region. Alternatively, where said viewed scene is generally rectangular, said input optical transformation means may optically compress just the opposite end regions thereof. Said input optical transformation means may comprise an anamorphic lens system comprising one or more lenses, or an arrangement of mirrors providing a similar transformation, or one or more refractive devices such as a Fresnel lens system. Said input optical transformation may comprise a barrel distortion or a modification thereof, and said output optical transformation may comprise a pin cushion distortion. Said input optical transformation means may optically compress said selected region in one or two dimensions.

In one embodiment, said display means comprises a head-mounted display including means for mounting the display on the head of a user in use, to move therewith. The sensor may comprise a rectangular array of sensor pixels, and likewise said display may comprise a rectangular array of display pixels. Each sensor pixel may correspond to a respective display element on a one-to-one mapping, or there may be different mappings.

In another aspect, this invention provides an image display system which comprises:

image generating means for generating image signal data corresponding to an image to be displayed;

a display for receiving said image data from said image generating means and displaying a corresponding image;

output optical transformation means for applying to said displayed image and output optical transformation in which a selective part thereof is optically expanded,

wherein said image generating means is operable to generate an image which, when transformed by said output transformation means, corresponds to the image to be displayed.

In another aspect, this invention provides an image compression method for compressing image data for storage and/or transmission, which comprises: applying to said image, or to data representative thereof, a transformation corresponding to one in which a selected part of said image is compressed relative to the remainder thereof to obtain compressed image data;

storing and/or transmitting said compressed image data together with the remaining image data, and

reconstructing said original image using the compressed data and original image data.

The invention extends also an optical compression device for use in a system as set out above, which comprises:

a sensor for receiving an incident image and generating image data for storage or transmission, and

an optical transformation means for applying a non-uniform optical transformation to radiation from a viewed scene before it is incident on said sensor, selectively to apply a greater optical compression to one or more peripheral regions compared to the remainder.

Additionally, the invention extends to an expansion device for use in a system as set out above, which comprises means for displaying image data representing a compressed image in which a non-uniform transformation has been applied to a real or notional image, said expansion device further including means for applying an expansion transformation before or after presentation on said display to thereby to present to a viewer a reproduction of said original real or notional image.

Whilst the invention has been described above, it extends to any inventive combination of the features set out herein.

The invention may be performed in many ways, and, by way of example only, various embodiments will now be described with reference to the accompanying drawings, in which:

FIG. 1 is a flow diagram illustrating the steps involved in a first embodiment of the invention;

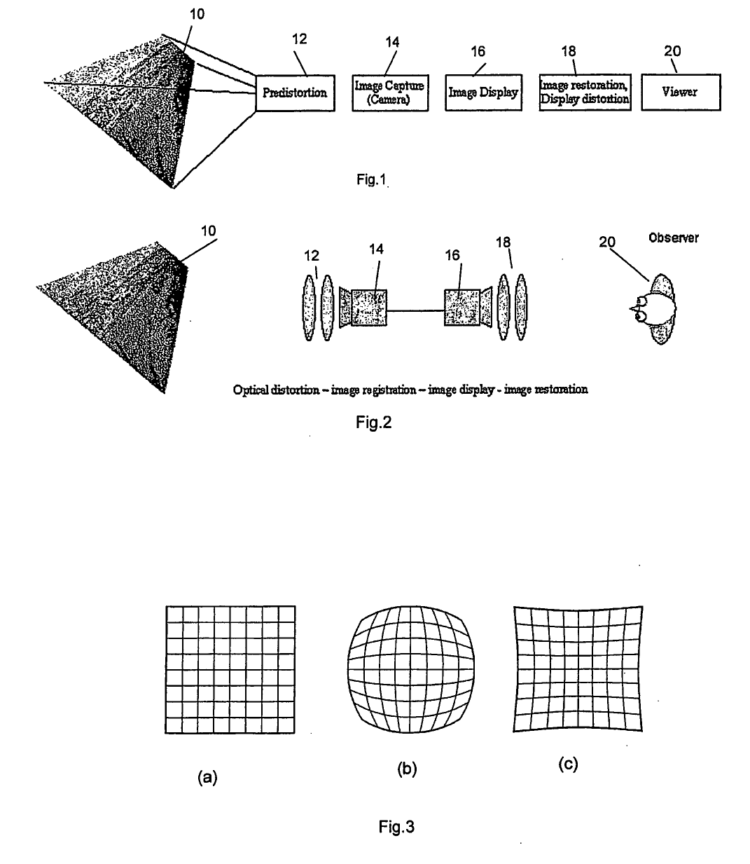

FIG. 2 is a schematic diagram showing the components required in said first embodiment of the invention;

FIGS. 3(a), (b) and (c) are respective views of a reference grid (with no distortion) and the same grid with negative (barrel) distortion and positive (pin cushion) distortion respectively;

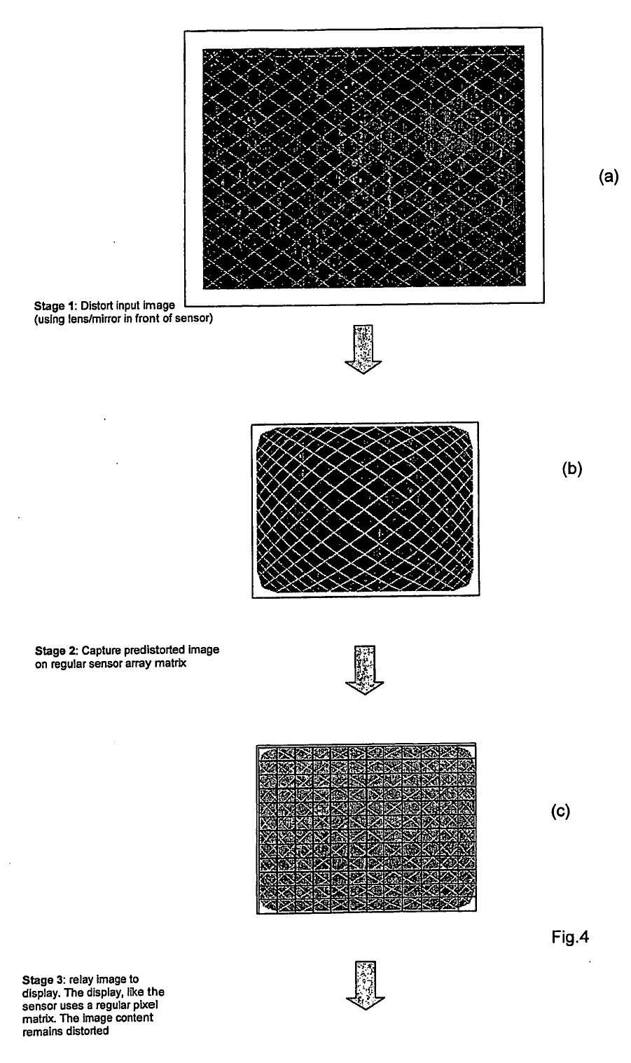

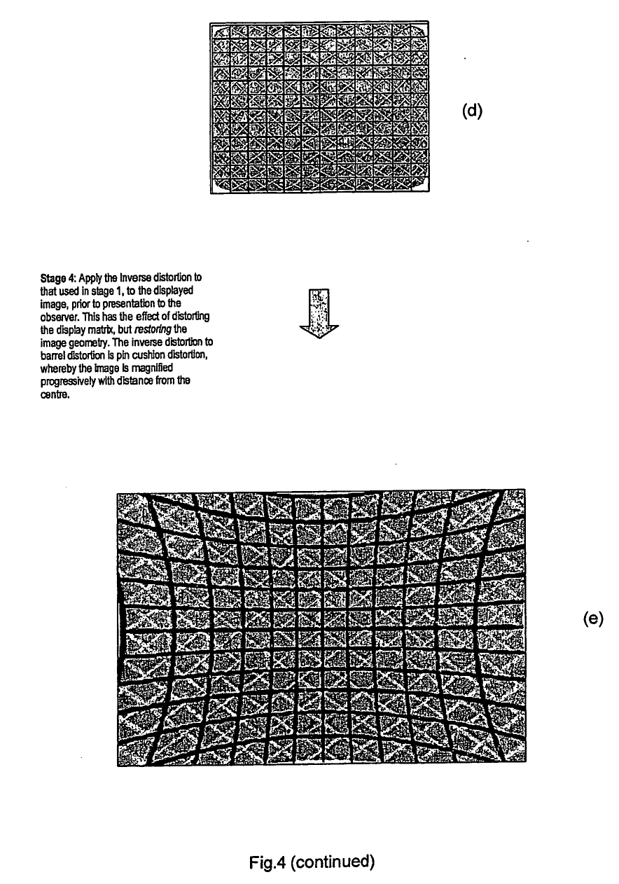

FIGS. 4(a) to (e) are illustrations representing the step by step method incorporated in an embodiment of the invention;

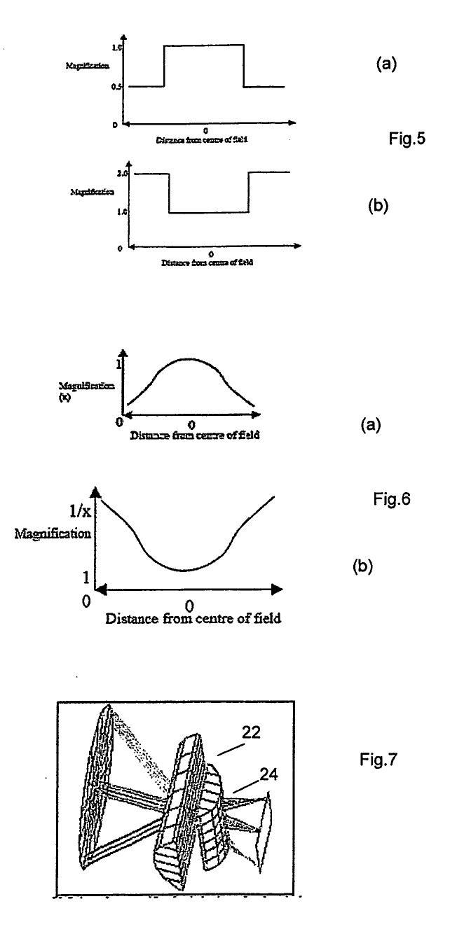

FIGS. 5(a) and (b) and 6(a) and (b) are respective compression/expansion profiles showing a stepped profile and a continuously varied profile respectively;

FIG. 7 is a schematic view of an optical arrangement for applying compression to a scene as it is imaged onto a sensor, and

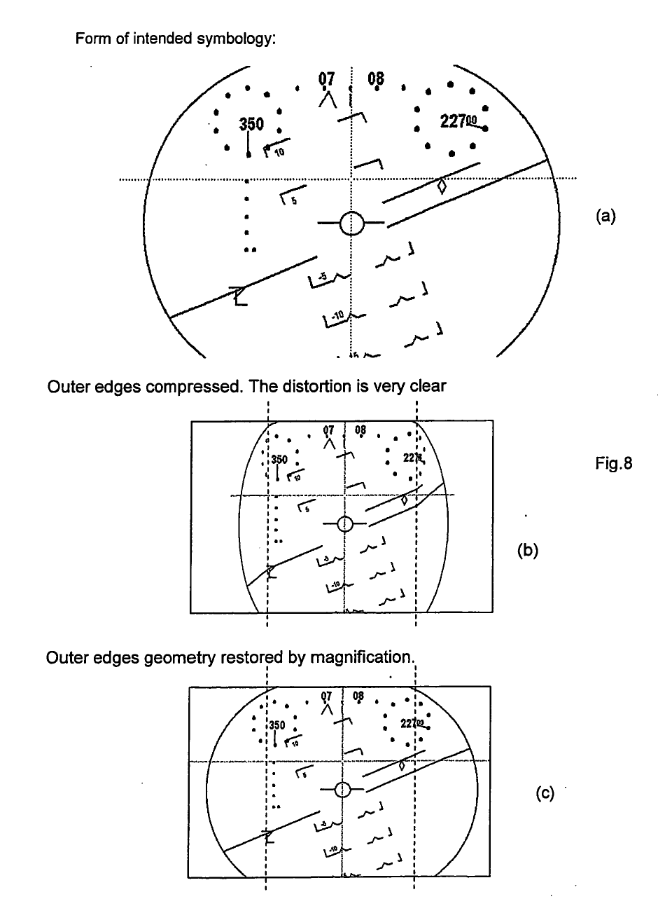

FIGS. 8(a) to (c) is a sequence showing digital pre-distortion of computer-generated symbology for display to a viewer.

Referring initially to FIGS. 1 and 2, in the first embodiment, a viewed scene 10 is subjected to a pre-distortion process or optical transformation at 12 prior to image capture on a camera or other suitable sensor 14. The displayed image from camera 14 is transmitted directly or retrieved from storage and presented at an image display 16. The image displayed on image display 16 undergoes an image restoration step 18 which distorts the image to undo the distortion applied prior to the sensor prior to presentation to a viewer. In this process, the display distortion at 18 is an exact optical inverse of the pre-distortion at 12 and so the image seen by the viewer 20 appears as an undistorted reproduction of the viewed scene.

The image capture device 14 and the display 16 are both pixellated devices and the display may typically have a resolution of 1280*1024 pixels. The function of the pre-distortion at 12 is to selectively compress optically an outer peripheral region of the image as incident on the capture device 14, whilst leaving the central region of the image substantially unchanged. The combined effect of this is that the optical resolution of the outer periphery of the image is less than that at the centre of the image because each pixel at the centre of the display will subtend a smaller angle than each pixel at the outer peripheral region. Due to the manner in which the display is used and the visual characteristics of the human eye, the lower peripheral resolution does not significantly affect the viewer's impression of the viewed scene. Thus a wider field of view can be captured by a sensor of a given size because the peripheral compression shrinks the size of the periphery of the image incident on the sensor so allowing a wider expanse of the image to be captured.

Referring now in more detail to the image processing, in this particular embodiment, the image processing at the camera 12 (otherwise referred to as a sensor) and display 16 are both done optically. Thus, referring to FIG. 4(a) there is shown a simplistic representation of a viewed scene which in this case comprises a mesh pattern chosen just to illustrate the successive optical transformations. In a first optical transformation a negative magnification or barrel distortion is applied at FIG. 4(b) using a lens and/or mirror system which has the effect of compressing the outer periphery of the image whilst leaving a central region substantially uncompressed, and the transformed image is made incident on the sensor 14 (FIG. 4(c)). It will be seen that the angle subtended by the image has been decreased and so this has the effect of increasing the image field of view which would otherwise be captured by the sensor. The size and resolution of the central area is 1:1 as seen by comparison of the cells of the mesh at the centre of the image (FIG. 4(c)) compared to those in FIG. 4(a) and the periphery alone has been compressed. In FIG. 4(c) the pre-distorted image is captured on the sensor 14 having a regular array matrix (illustrated schematically by the dark-lined X-Y grid). Comparison of this regular grid with the light diagonal mesh illustrates the distortion. The sensor 14 generates electronic image data in a conventional fashion which may be stored for later retrieval or, as in the present embodiment, relayed directly to the display 16 which reproduces the image seen by the sensor 14. The display 16, like the sensor, uses a regular pixel matrix and it will be seen that the image content remains distorted (FIG. 4(d)). The displayed image is then subjected to an optical transformation which applies an inverse distortion to that used in FIG. 4(b) to the displayed image, prior to presentation to the observer. This has the effect of distorting the display matrix but of restoring the image geometry. The inverse distortion to barrel distortion is pin cushion distortion FIG. 3(c), whereby the image is magnified progressively with distance from the centre. As will be seen, in the image presented to the observer FIG. 4(e), the image content (represented by the light diagonal mesh) is restored to present the image of FIG. 4(a) with the image quality being optimal at the centre but having poorer resolution at the periphery. The display matrix (represented by the dark lines) is no longer regular, but magnified in the periphery, although of course this is not seen by the user.

The result is that there is an increased field of view, with reduced image resolution towards the edge of the field. The image geometry is restored, but the display matrix is distorted.

This embodiment therefore provides an arrangement whereby a readily available display device may be used to provide a wider field of view than hitherto whilst maintaining good resolution at the centre and lower resolution at the periphery where a lower resolution produces little or no effect to the image perceived by the user This is particularly, but not exclusively, of benefit where the display is used in a head-related display where the reduced resolution at the periphery of the displayed image corresponds to that of the human eye.

In practice, numerous different types of optical transformation may be applied in order to achieve this effect. It is preferred, but by no means essential, for the optical transformation applied to the image displayed by the display to be the inverse of that applied to the viewed scene before it is incident on the detector. FIGS. 5(a) and (b) and FIGS. 6(a) and (b) show some examples of respective compression and expansion transformations, to show that the transformation may be stepped or vary continuously. In these embodiments, the optical transformations effecting the compression and expansion are solely geometric.

It will be appreciated that this embodiment not only has the effect of allowing a lower resolution display to be used with a consequent beneficial effect on cost and computational requirements, but also the perceived quality of the image is relatively high given the number of pixels used. Therefore, as well as allowing a lower resolution display, this embodiment also makes possible a reduction of the amount of digital data required to store an image with a given perceived resolution. Thus similar techniques may be used in order to provide data compression to reduce the amount of digital data required to store or transmit the image, and the invention extends to such apparatus and methods.

For example, a high resolution digital image may be subjected to a digital transformation which digitally compresses a peripheral region of the image whilst leaving a central region uncompressed. This reduces the digital size of the image to reduce storage requirements or transmission times. When the image is to be displayed a transformation is applied to undo the original digital distortion. This could be done digitally, by digital transformation to map the pixels of the image data onto the display pixels so as to reproduce the original image without significant spatial distortion, or optically, by applying the image data to a display to display the image distorted by the original digital transformation, and then optically transforming the image to reproduce the original image.

In the embodiments of FIGS. 1 to 6, the input image is transformed anamorphically by means of mirrors or lenses. FIG. 7 shows an arrangement in which two orthogonally arranged cylinder lenses 22, 24 apply vertical and horizontal compression respectively. Transforming the image optically has the principal advantage of real time processing as there is no significant processing delay, and also has the advantage of not increasing the computational requirement but it would of course be possible in other situations to transform the image data digitally to provide a similar effect. This might be appropriate, for example, where the sensor has many more pixels than the display, for example the digital transformation could combine the outputs from several sensor pixels and combine them to map to a single display pixel.

In addition, the digital transformation of the image may be required where computer-generated symbology is displayed. Thus, as shown in FIG. 8(a), an image may be generated by a computer which is then digitally transformed as shown in FIG. 8(b) prior to transmission to the display where, to compress the left and right side regions using a mirror and/or lens system as in the previous embodiment, it is restored to the original form as shown in FIG. 8(c). It will of course be appreciated that this digital transformation of information may be superimposed on camera-derived data captured and processed according to FIGS. 1 to 4.

Although it is preferable in the various embodiments to restore the image so that it is a generally faithful reproduction of the original image, in some cases, it may not be necessary fully to restore the compressed peripheral region; it may even be possible to display the distorted image without any restoration at all, with the viewer's brain appropriately interpreting the squashed or compressed outer peripheral region. The digital information to compress the image in one or two dimensions is relatively straightforward and will not be described in detail here. Options include scaling the image with a factor that varies with distance from the centre.

Whilst the above embodiment has been described with reference to a system in which image data is captured and/or generated in real time and presented to a user via a display, in another embodiment, these same techniques may be used to compress the amount of digital data required to store an image. Thus, for example, to reduce the amount of data and/or increase the download speed of an image from the internet, an original image may be digitally transformed so as to provide a central region at relatively high resolution and an outer peripheral region stored at a lower resolution to reduce the amount of pixels to be stored. On downloading or retrieving an image for display, the device transforms the image digitally or optically to stretch it so that the outer periphery expands to the original size relative to the central region.

As with the head-up display this technique is particularly, but not exclusively, of benefit where the user is able to pan the viewed frame across an image to centre it on an area of interest for closer inspection. The method would particularly suit any application where the subject of interest can be brought to the centre of the display—ie similar to head-related display, for example CCTV systems with manual or automatic tracking, other equivalent surveillance systems and other forms of tracking cameras/webcams.

1. An image display system comprising:
a sensor for receiving from a field of view an incident image and generating corresponding image data;
an input optical transformer for applying an input optical transformation to radiation from said viewed scene before being incident upon said sensor, and
a display for receiving image data from said sensor and for displaying an image generally corresponding to the image incident on said sensor,
wherein said input optical transformer is configured to apply the input optical transformation by optically compressing a selected part of said incident image in at least one dimension.

2. An image display system according to claim 1, further comprising an output optical transformer for applying an output optical transformation to the image displayed by said display for presentation to a user, wherein said output optical transformer is configured to apply the output optical transformation by optically expanding a part of the displayed image generally corresponding to that compressed by said input optical transformer, to at least partially restore the displayed image to correspond to that of the viewed scene.

3. An image display system according to claim 1, wherein said input optical transformer is configured to optically compress a peripheral region of said viewed scene.

4. An image display system according to claim 3, wherein the input optical transformer is configured to optically compress a peripheral border region extending around a generally central region.

5. An image display system according to claim 3, wherein said viewed scene is generally rectangular and said input optical transformer is configured to optically compress opposite end regions thereof.

6. An image display system according to claim 1, wherein said input optical transformer comprises an anamorphic lens system comprising one or more lenses.

7. An image display system according to claim 4, wherein the input optical transformation which said input optical transformer is configured to apply comprises a barrel distortion.

8. An image display system according to claim 7 further comprising an output optical transformer for applying an output optical transformation to the image displayed by said display for presentation to a users wherein said output optical transformer is configured to apply the output optical transformation by optically expanding a part of the displayed image generally corresponding to that compressed by said input optical transformer, to at least partially restore the displayed image to correspond to that of the viewed scene, and, wherein said output optical transformation which the output optical transformer is configured to apply comprises a pin cushion distortion.

9. An image display system according to claim 1, wherein said input optical transformer is configured to optically compress said selected region in two dimensions.

10. An image display system according to claim 1, wherein said display comprises a head-mounted display including a mount for mounting the display on the head of a user in use, to move therewith.

11. An image display system according to claim 1, wherein said sensor comprises a rectangular array of sensor pixels.

12. An image display system according to claim 1, wherein said display comprises a rectangular array of display pixels.

13. An image display system according to claim 12, wherein said sensor comprises a rectangular array of sensor pixels, and wherein each sensor element corresponds to a respective display element.

14. An image display system which comprises:
an image generator for generating image signal data corresponding to an image to be displayed;
a display for receiving said image data from said image generator and displaying a corresponding image;
an output optical transformer for applying to said displayed image an output optical transformation in which a selective part thereof is optically expanded,
wherein said image generator is operable to generate an image which, when transformed by said output optical transformer corresponds to the image to be displayed.

15. An image compression method for compressing image data for storage and/or transmission, which comprises
applying to said image, or to data representative thereof, a transformation corresponding to one in which a selected part of said image is compressed relative to the remainder thereof to obtain compressed image data;
storing and/or transmitting said compressed image data together with the remaining image data, and
reconstructing said original image using the compressed data and original image data.

16. An optical compression device for use in a system according to claim 1, which comprises
a sensor for receiving an incident image and generating image data for storage or transmission, and
an optical transformer for applying a non-uniform optical transformation to radiate from a viewed scene before it is incident on said sensor, selectively to apply a greater optical compression to one or more peripheral regions compared to the remainder.

17. An expansion device for use in a system according to claim 1, which comprises a display for displaying image data representing a compressed image in which a non-uniform transformation has been applied to a real or notional image, said expansion device further including an expansion transformer for applying an expansion transformation before or after presentation on said display to thereby to present to a viewer a reproduction of said original real or notional image.
